(19) United States
(12) Patent Application Publication
(10) Pub. No.: US 2019/0286420 A1
(43) Pub. Date: Sep. 19, 2019

(54) Processor and Arithmetic Processing Device Having the Same

(71) Applicant: Yamaha Corporation, Hamamatsu-shi (JP)

(72) Inventor: Tomoaki ANDO, Hamamatsu-shi (JP)

(21) Appl. No.: 16/427,992

(22) Filed: May 31, 2019

Related U.S. Application Data
(63) Continuation of application No. PCT/JP2017/042227, filed on Nov. 24, 2017.

(30) Foreign Application Priority Data
Dec. 1, 2016 (JP) 2016-234306

(51) Int. Cl. G06F 7/575; G06F 7/50; G06F 15/167

(52) U.S. Cl. CPC G06F 7/575; G06F 15/167; G06F 7/50

(57) ABSTRACT

A processor includes a plurality of arithmetic and logic units configured to operate in parallel with one another and a first reduction circuit including a first adder configured to simultaneously add together a plurality of arithmetic results output from the plurality of arithmetic and logic units. Further, an arithmetic processing device includes a plurality of processors each including the plurality of arithmetic and logic units configured to operate in parallel with one another and a first reduction circuit including a first adder configured to simultaneously add together a plurality of arithmetic results output from the plurality of arithmetic and logic units.

### CROSS-REFERENCE TO RELATED APPLICATIONS

This application is a U.S. continuation application filed under 35 U.S.C. § 111(a), of International Application No. PCT/JP2017/042227, filed on Nov. 24, 2017, which claims priority to Japanese Patent Application No. 2016-234306, filed on Dec. 1, 2016, the disclosures of which are incorporated by reference.

### FIELD

The present invention relates to a processor and an arithmetic processing device including the processor.

### BACKGROUND

As an arithmetic processing device, an SIMD (single instruction multiple data) parallel arithmetic processing device has been known that applies a single instruction to a plurality of data columns and processes them in parallel. For example, Japanese Unexamined Patent Application Publication No. H11-296498 discloses a technology for executing reduction operations of a plurality of arithmetic units.

### SUMMARY

According to an embodiment of the present invention, a processor comprising: a plurality of arithmetic and logic units configured to operate in parallel with one another; and a first reduction circuit including a first adder configured to simultaneously add together a plurality of arithmetic results output from the plurality of arithmetic and logic units is provided.

According to an embodiment of the present invention, an arithmetic processing device comprising: a plurality of processors, each of the plurality of processors including a plurality of arithmetic and logic units configured to operate in parallel with one another and a first reduction circuit including a first adder configured to simultaneously add together a plurality of arithmetic results output from the plurality of arithmetic and logic units is provided.

According to an embodiment of the present invention, an arithmetic processing method including: performing a plurality of arithmetic operations and/or logic operations in parallel; and simultaneously adding together arithmetic results of the plurality of arithmetic operations and/or logic operations wherein when the number of the arithmetic results is 2ⁿ, (where n is an integer of 2 or greater), simultaneously adding together the arithmetic results is calculating 2ⁿ⁻¹ addition results by adding together the 2ⁿ arithmetic results and repeating addition until n−1 becomes 0.

### BRIEF DESCRIPTION OF THE DRAWINGS

FIG. 1 is a block diagram showing a configuration of a digital signal processing device according to an embodiment of the present invention;

FIG. 2 is a block diagram showing an example of a configuration of the digital signal processing device according to the embodiment of the present invention;

FIG. 3 is a block diagram for explaining examples of addition operations by a processor according to the embodiment of the present invention;

FIG. 4 is a block diagram showing an example of a configuration of the digital signal processing device according to an embodiment of the present invention;

FIG. 5 is a block diagram showing an example of a configuration of the digital signal processing device according to an embodiment of the present invention; and

FIG. 6 is a block diagram showing an example of a configuration of the digital signal processing device according to an embodiment of the present invention.

### DESCRIPTION OF EMBODIMENTS

An embodiment of the present invention is described in detail below with reference to the drawings. The embodiment to be hereinafter prescribed is an example of an embodiment of the present invention, and the present invention is not limited to the embodiment. It should be noted that in the drawings that are referred to in the present embodiment, identical components or components having similar functions are given identical or similar signs, and a repeated description of them may be omitted.

The technology disclosed in Japanese Unexamined Patent Application Publication No. H11-296498, in which reduction operations of a plurality of arithmetic units are performed in sequence for each arithmetic unit, have been undesirably unable to successively perform reduction operations.

According to an embodiment to be described below, there is provided an arithmetic processing device that can simultaneously perform reduction operations of a plurality of arithmetic units.

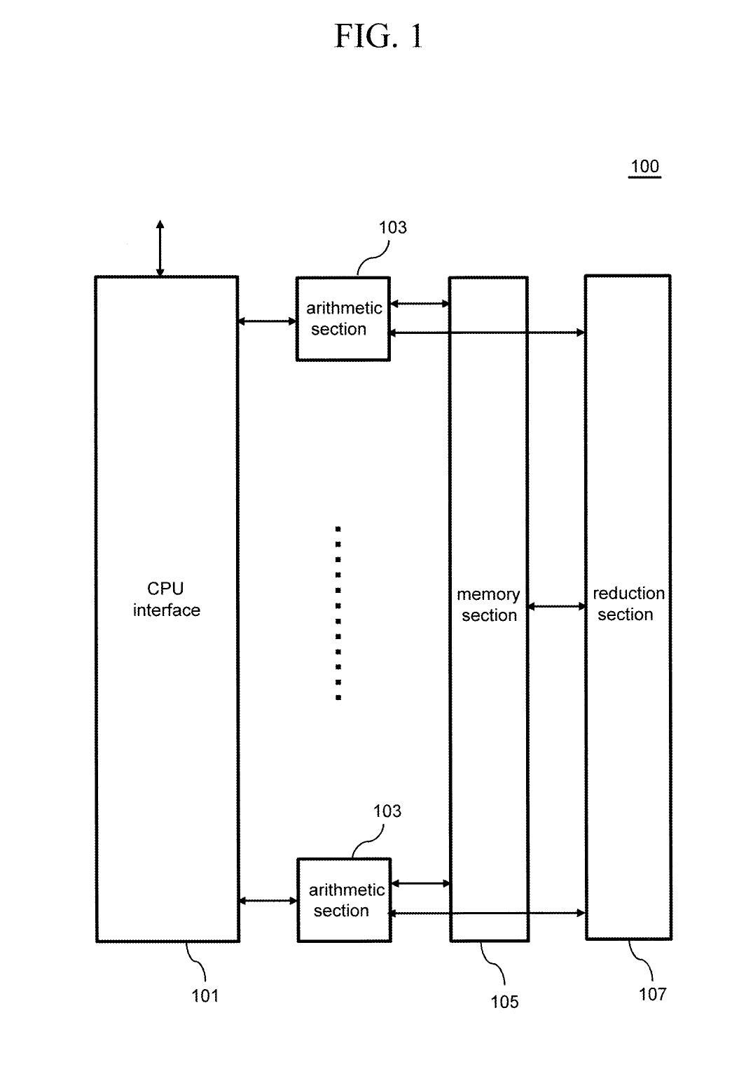

FIG. 1 is a block diagram showing a configuration of a digital signal processing device (arithmetic processing device) 100 according to an embodiment of the present invention. The digital signal processing device 100 includes a CPU interface 101, a plurality of arithmetic sections 103 (which correspond to the after-mentioned processors), and a memory section 105. The digital signal processing device 100 may include a reduction section 107 (which corresponds to the after-mentioned second reduction circuit 211).

The CPU interface 101 controls a connection between a CPU (not illustrated) and the arithmetic sections 103. Specifically, the CPU interface 101 receives, from the CPU, a program and data that indicate a procedure, and transmits the program and the data to the plurality of arithmetic sections 103.

The plurality of arithmetic sections 103 perform processing of data on the basis of the program and data received from the CPU via the CPU interface 101. A configuration of each arithmetic section 103 will be described later.

The memory section 105 includes an arbitration circuit (which corresponds to the after-mentioned arbitration circuit 221) and a memory (which corresponds to the after-mentioned memory 223). The memory is constituted of a RAM and retains arithmetic results yielded by the arithmetic sections 103.

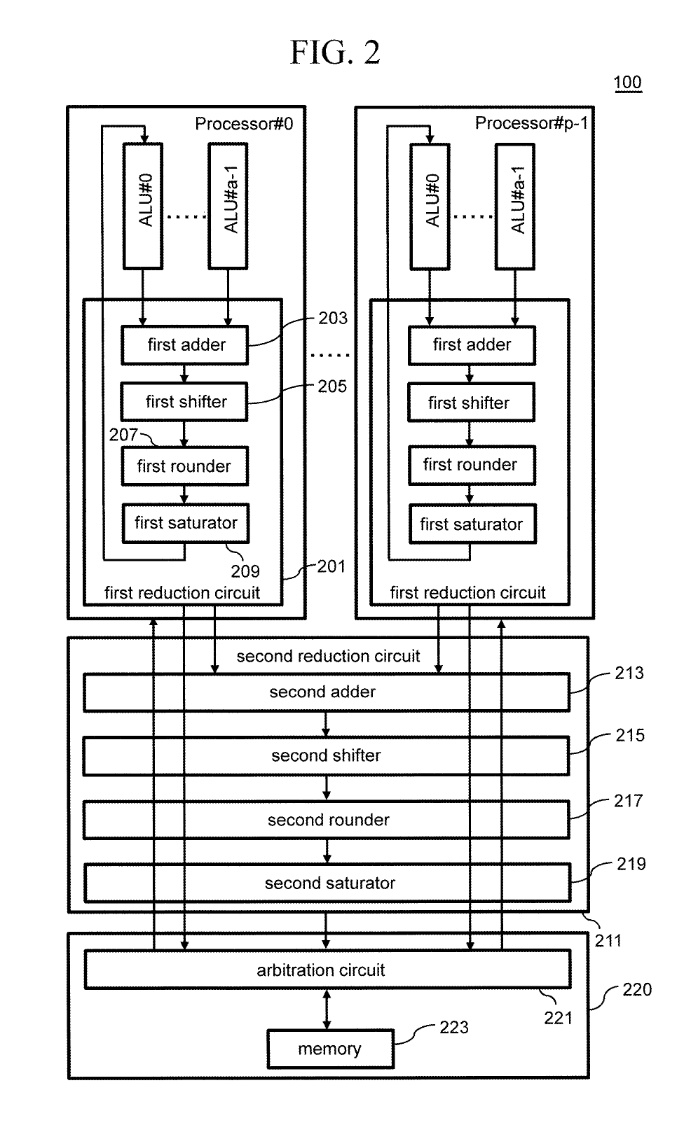

FIG. 2 is a block diagram showing an example of a configuration of the digital signal processing device 100 according to the embodiment of the present invention. It should be noted that FIG. 2 omits to illustrate the CPU interface 101.

As shown in FIG. 2, the digital signal processing device 100 includes p (a plurality of) arithmetic sections. The arithmetic section are hereinafter referred to as “processors”, and the p processors are referred to as “processor #0”, “processor #1”, . . . , “processor #p-2”, and “processor #p-1”, respectively. The processors #0 to #p-1 correspond to the arithmetic sections 103 shown in FIG. 1. Each of the processors #0 to #p-1 includes a (a plurality of) arithmetic and logic units ALU #0 to ALU #a-1 and a reduction circuit 201 (hereinafter referred to as “first reduction circuit 201”) that corresponds to the a ALUs. Further, as mentioned above, the digital signal processing device 100 includes a reduction circuit 211 (hereinafter referred to as “second reduction circuit 211”) that reduces arithmetic results respectively yielded by the p processors and a memory section 220 including a memory 223 and an arbitration circuit 221 that receives arithmetic results yielded by the p processors and transmits the arithmetic results thus received to the memory 223 in sequence. Note here that the second reduction circuit 211 corresponds to the reduction section 107 shown in FIG. 1 and the memory section 220 corresponds to the memory section 105 shown in FIG. 1.

Each of the a ALUs of each of the processors #0 to #p-1 includes a multiplier, an adder, a register, a shifter, a saturator, and the like and performs an arithmetic operation and/or a logic operation. Of the a ALUs of each of the processors #0 to #p-1, the ALU #0 is hereinafter referred to as “first-stage ALU” and the ALU #a-1 is hereinafter referred to as “final-stage ALU”. The a ALUs of each processor are configured to operate in parallel with one another, and arithmetic results yielded by each separate ALU are simultaneously output in synchronization with a clock signal.

The first reduction circuit 201 is configured to reduce a plurality of arithmetic results output from the a ALUs. The first reduction circuit 201 includes an adder 203 (hereinafter referred to as “first adder 203”) that is configured to simultaneously add together a plurality of arithmetic results output from the a ALUs. That is, the first adder 203 is configured to simultaneously add up a arithmetic results respectively output from the a ALUs. The a ALUs may simultaneously output arithmetic results, respectively.

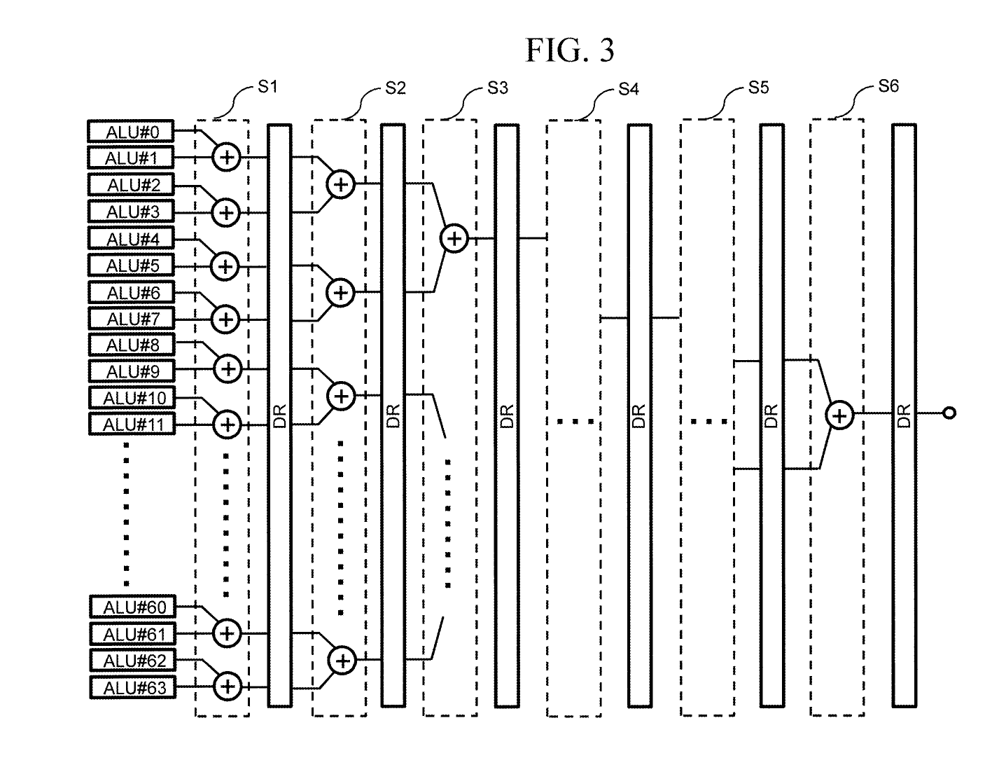

FIG. 3 is a block diagram for explaining examples of additions that the first adder 203 executes. Although FIG. 3 shows that one processor includes 64 units, namely ALUs #0 to #63, the number of ALUs that each processor has is not limited to 64 units.

As shown in FIG. 3, first, arithmetic results simultaneously output from the 64 ALUs #0 to #63 in synchronization with an nth clock signal are executed to addition operations (S1). Specifically, an arithmetic result yielded by the ALU #0 and an arithmetic result yielded by the ALU #1, an arithmetic result yielded by the ALU #2 and an arithmetic result yielded by the ALU #3, an arithmetic result yielded by the ALU #4 and an arithmetic result yielded by the ALU #5, . . . , an arithmetic result yielded by the ALU #60 and an arithmetic result yielded by the ALU #61, and an arithmetic result yielded by the ALU #62 and an arithmetic result yielded by the ALU #63 are respectively added together. That is, the 64 arithmetic results that are output from the 64 ALUs #0 to #63 are simultaneously added together two by two in one clock cycle. The 32 arithmetic results generated in S1 are temporarily stored in a data register (DR).

Next, the arithmetic results obtained in S1 are read out from the data register in synchronization with an (n+1)th clock signal and added together (S2). Specifically, the arithmetic result generated by adding the arithmetic results from the ALUs #0 and #1 and the arithmetic result generated by adding the arithmetic results from the ALUs #2 and #3 are added together. At the same time, the arithmetic result generated by adding the arithmetic results from the ALUs #4 and #5 and the arithmetic result generated by adding the arithmetic results from the ALUs #6 and #7 are added together. The arithmetic results in S1 generated from the arithmetic results yielded by the ALU #8 and the subsequent ALUs are added together in a similar way. That is, in S2, the 32 arithmetic results obtained in S1 are simultaneously added together two by two in one clock cycle, so that sixteen arithmetic results are generated. The sixteen arithmetic results generated in S2 are temporarily stored in a data register (DR).

Next, the arithmetic results obtained in S2 are read out from the data register in synchronization with an (n+2)th clock signal and added together (S3). Specifically, the arithmetic result generated by adding the arithmetic results from the ALUs #0 to #3 and the arithmetic result generated by adding the arithmetic results from the ALUs #4 to #7 are added together. At the same time, the arithmetic result generated by adding the arithmetic results from the ALUs #8 to #11 and the arithmetic result generated by adding the arithmetic results from the ALUs #12 to #15 are added together. The arithmetic results generated from the arithmetic results yielded by the ALU #16 and the subsequent ALUs are added together in a similar way. That is, in S3, the sixteen arithmetic results obtained in S2 are simultaneously added together two by two in one clock cycle, so that eight arithmetic results are generated. The eight arithmetic results generated in S3 are temporarily stored in a data register (DR).

Next, the arithmetic results obtained in S3 are read out from the data register in synchronization with an (n+3)th clock signal and added together (S4). Specifically, the arithmetic result generated by adding the arithmetic results from the ALUs #0 to #7 and the arithmetic result generated by adding the arithmetic results from the ALUs #8 to #15 are added together. At the same time, the arithmetic result generated by adding the arithmetic results from the ALUs #16 to #23 and the arithmetic result generated by adding the arithmetic results from the ALUs #24 to #31 are added together. The arithmetic results generated from the arithmetic results yielded by the ALU #32 and the subsequent ALUs are added together in a similar way. That is, in S4, the eight arithmetic results obtained in S3 are simultaneously added together two by two in one clock cycle, so that four arithmetic results are generated. The four arithmetic results generated in S4 are temporarily stored in a data register (DR).

Next, the arithmetic results obtained in S4 are read out from the data register in synchronization with an (n+4)th clock signal and added together (S5). Specifically, the arithmetic result generated by adding the arithmetic results from the ALUs #0 to #15 and the arithmetic result generated by adding the arithmetic results from the ALUs #16 to #31 are added together. At the same time, the arithmetic result generated by adding the arithmetic results from the ALUs #32 to #47 and the arithmetic result generated by adding the arithmetic results from the ALUs #48 to #63 are added together. That is, in S5, the four arithmetic results obtained in S4 are simultaneously added together two by two in one clock cycle, so that two arithmetic results are generated. The two arithmetic results generated in S5 are temporarily stored in the data register (DR).

Next, the arithmetic results obtained in S5 are read out from the data register in synchronization with an (n+5)th clock signal and added together (S6). Specifically, the arithmetic result generated by adding the arithmetic results from the ALUs #0 to #31 and the arithmetic result generated by adding the arithmetic results from the ALUs #32 to #63 are added together. An arithmetic result generated in S6 is temporarily stored in a data register (DR), and is simultaneously output in synchronization with an (n+6)th clock signal.

As mentioned above, the first adder 203 is configured to simultaneously and successively add up a plurality of arithmetic results, output from the plurality of ALUs, whose number corresponds to the number of ALUs. This makes it possible to perform successive reduction operations unlike the conventional technology, in which reduction operations of a plurality of ALUs (arithmetic units) are performed in sequence one by one for each ALU. That is, this makes it possible to perform reduction operations by pipeline processing.

It should be noted that the numbers of steps of addition that the first adder 203 executes and clocks that are needed for addition are not limited by the aspect described with reference to FIG. 3; for example, addition may be executed using an adder with three or more inputs. Further, although, in the aspect described with reference to FIG. 3, single-stage addition is performed per one clock cycle (S1 to S6), multiple-stage addition may be executed per one clock cycle.

With continued reference to FIG. 2, the configuration of the digital signal processing device 100 according to the embodiment of the present invention is described. The first reduction circuit 201 of each of the processors #0 to #p-1 may include a shifter 205 (hereinafter referred to as “first shifter 205”) that is configured to shift an arithmetic result yielded by the first adder 203, a rounder 207 (hereinafter referred to as “first rounder 207”) that is configured to perform a rounding process on the arithmetic result thus shifted, and a saturator 209 (hereinafter referred to as “first saturator 209”) that is configured to perform a saturation process on the arithmetic result subjected to the rounding process.

The first shifter 205 receives an arithmetic result output from the first adder 203 and performs a shift operation on the arithmetic result from the first adder 203 thus received. The arithmetic result shifted by the first shifter 205 may be transmitted to the first rounder 207.

The first rounder 207 performs, on the arithmetic result thus shifted, a rounding process such as nearest neighbor rounding, rounding in a 0 direction, rounding to +∞, or rounding to −∞. The arithmetic result subjected to the rounding process may be transmitted to the first saturator 209. The first saturator 209 performs a saturation process on the arithmetic result subjected to the rounding process thus received.

Arithmetic results obtained in the first reduction circuits 201 of the processors #0 to #p-1 are simultaneously output from the processors #0 to #p-1, respectively, in synchronization with a clock signal. In a case where the first shifter 205, the first rounder 207, and the first saturator 209 are omitted from each of the processors #0 to #p-1, the arithmetic result yielded by the first adder 203 is output from each of the processors #0 to #p-1 as their arithmetic result respectively. In a case where the first reduction circuit 201 of each of the processors #0 to #p-1 include the first shifter 205, the first rounder 207, and/or the first saturator 209, an arithmetic result yielded by the first shifter 205, the first rounder 207, or the first saturator 209 may be output from each of the processors #0 to #p-1 as their arithmetic result respectively.

Further, the arithmetic result obtained in the first reduction circuit 201 may be transmitted to ALUs of the corresponding processor as needed. FIG. 2 shows how the arithmetic result yielded by the first saturator 209 is transmitted to an ALU of the corresponding processor. Although FIG. 2 shows how the arithmetic result yielded by the first saturator 209 is transmitted to only an ALU #0 of the corresponding processor, the arithmetic result may be transmitted to all of the ALUs #0 to #a-1 or may be transmitted to any plurality of ALUs of the corresponding processor. It should be noted that in a case where the first shifter 205, the first rounder 207, and the first saturator 209 are omitted from each of the processors #0 to #p-1, the arithmetic result from the first reduction circuit 201 that are transmitted to an ALU/ALUs of the corresponding processor may be the arithmetic result yielded by the first adder 203 in each of the processors #0 to #p-1. Further, the arithmetic result from the first reduction circuit 201 that is transmitted to an ALU/ALUs of the corresponding processor may be the arithmetic result yielded by the first shifter 205 or the first rounder 207 in each of the processors #0 to #p-1.

Arithmetic results that are respectively output from the processors #0 to #p-1 are transmitted to the memory section 220. In so doing, the arithmetic results that are respectively output from the processors #0 to #p-1 are transmitted to the memory section 220 through the second reduction circuit 211, which receives arithmetic results that are respectively output from the p processors #0 to #p-1 and reduces the arithmetic results thus received. Alternatively, the arithmetic results that are respectively output from the processors #0 to #p-1 may be transmitted to the memory section 220 without passing through the second reduction circuit 211.

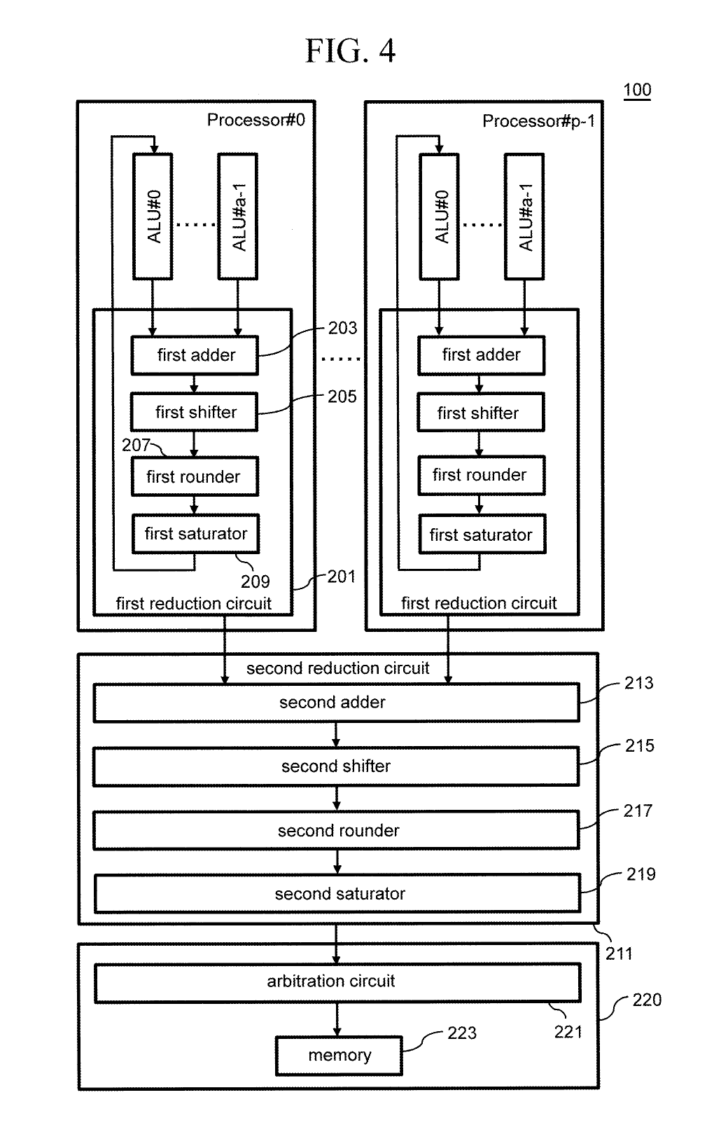

FIG. 4 is a block diagram showing a configuration in which arithmetic results respectively output from the processors #0 to #p-1 are transmitted to the second reduction circuit 211. The second reduction circuit 211 includes an adder 213 (hereinafter referred to as “second adder 213) that is configured to simultaneously add together a plurality of arithmetic results respectively output from the p processors #0 to #p-1. That is, the second adder 213 is configured to simultaneously and successively add up p arithmetic results simultaneously output from the respective p processors. This makes it possible to perform successive reduction operations unlike the conventional technology, in which reduction operations of a plurality of processors are performed in sequence one by one for each processor. That is, this makes it possible to perform reduction operations by pipeline processing. Addition operations in the second adder 213 are not described in detail, as they are similar to addition operations in the aforementioned first adder 203.

The second reduction circuit 211 may include a shifter 215 (hereinafter referred to as “second shifter 215”) that is configured to shift the arithmetic result yielded by the second adder 213, a rounder 217 (hereinafter referred to as “second rounder 217”) that is configured to perform a rounding process on the arithmetic result thus shifted, and a saturator 219 (hereinafter referred to as “second saturator 219”) that is configured to perform a saturation process on the arithmetic result subjected to the rounding process.

The second shifter 215 receives the arithmetic result output from the second adder 213 and performs a shift operation on the arithmetic result from the second adder 213 thus received. The arithmetic result shifted by the second shifter 215 may be transmitted to the second rounder 217.

The second rounder 217 performs, on the arithmetic result thus shifted, a rounding process such as nearest neighbor rounding, rounding in a 0 direction, rounding to +∞, or rounding to −∞. The arithmetic result subjected to the rounding process may be transmitted to the second saturator 219. The second saturator 219 performs a saturation process on the arithmetic result subjected to the rounding process thus received.

The arithmetic result obtained in the second reduction circuit 211 is transmitted to the arbitration circuit 221 of the memory section 220 and transmitted to the memory 223 through the arbitration circuit 221. In a case where the second shifter 215, the second rounder 217, and the second saturator 219 are omitted, the second reduction circuit 211 outputs, as its arithmetic result, the arithmetic result yielded by the second adder 213. In a case where the second reduction circuit 211 includes the second shifter 215, the second rounder 217, and/or the second saturator 219, the second reduction circuit 211 may output, as its arithmetic result, an arithmetic result yielded by the second shifter 215, the second rounder 217, or the second saturator 219.

Although the foregoing has described, with reference to FIG. 4, a configuration in which arithmetic results respectively output from the p processors #0 to #p-1 are transmitted to an external memory 3 through the second reduction circuit 211, the second reduction circuit 211 may be omitted from the arithmetic processing device according to the present invention.

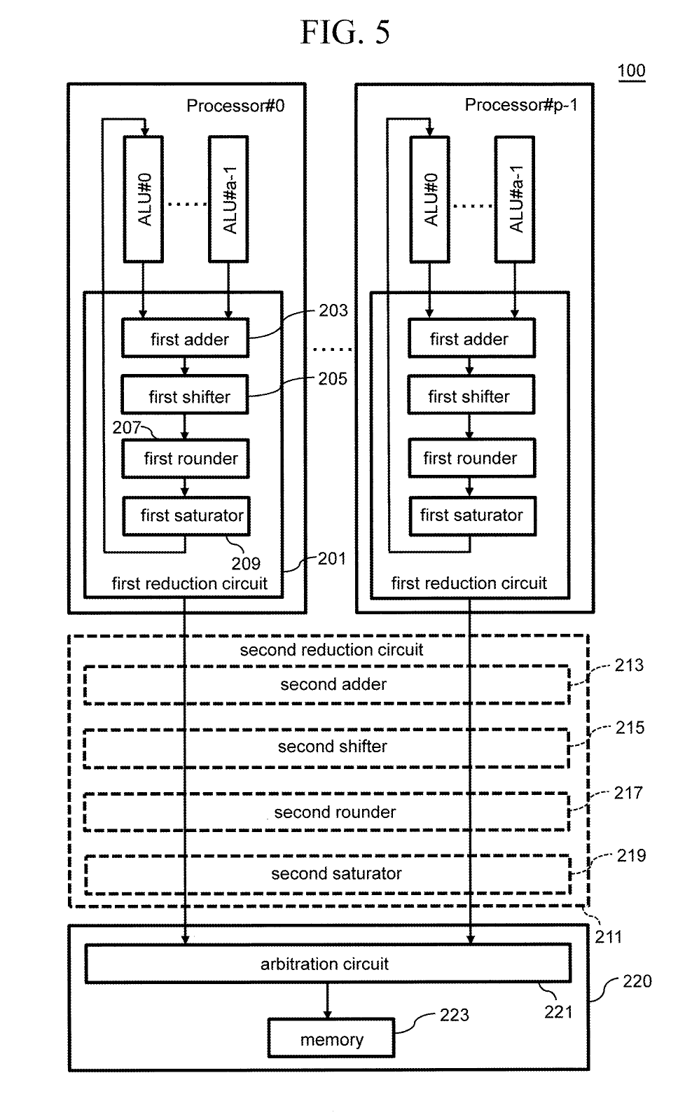

FIG. 5 is a block diagram showing a configuration in which arithmetic results respectively output from the processors #0 to #p-1 are transmitted to the memory section 220 without passing through the second reduction circuit 211. Arithmetic results from the respective p processors #0 to #p-1 are outputted to the arbitration circuit 221 of the memory section 220, and the arbitration circuit 221 transmits the p arithmetic results thus received to the memory 223 in sequence.

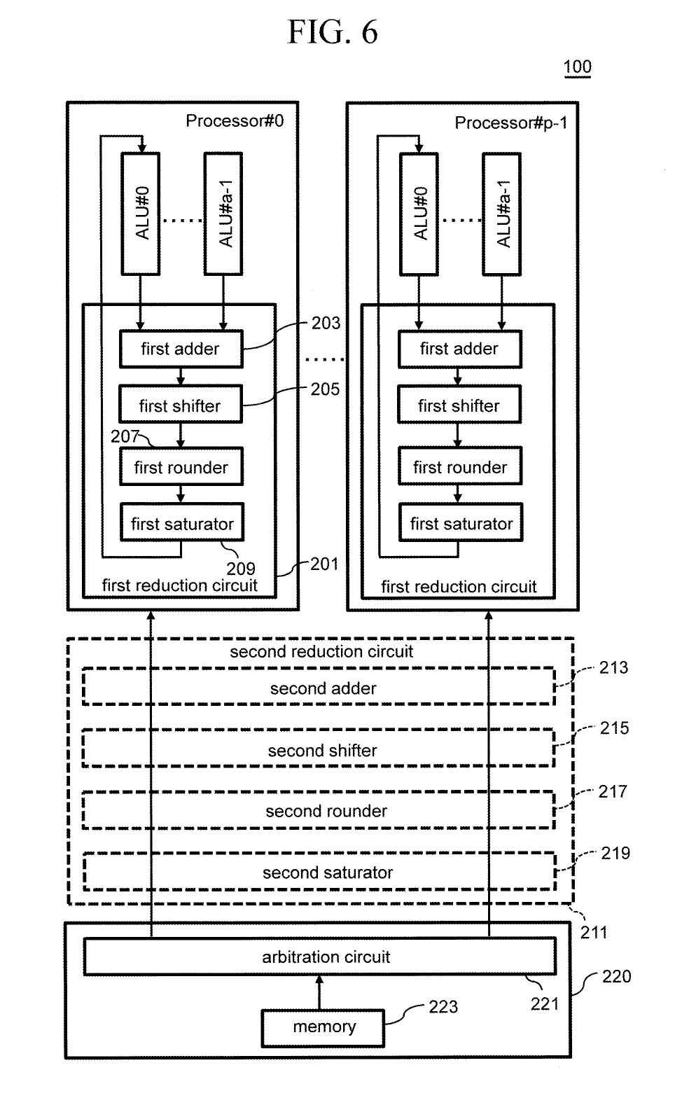

It should be noted that the arbitration circuit 221 may acquire arithmetic results retained in the memory 223 and transmit the arithmetic results thus acquired to the processors #0 to #p-1 in sequence. FIG. 6 is a block diagram showing a configuration in which the arithmetic result/results acquired by the arbitration circuit 221 is/are transmitted to the processors #0 to #p-1.

It should be noted that the present invention is not limited to the embodiment described above but may be altered as appropriate without departing from the scope of the present invention.

What is claimed is:

1. A processor comprising:
a plurality of arithmetic and logic units configured to operate in parallel with one another; and
a first reduction circuit including a first adder, the first adder configured to simultaneously add together a plurality of arithmetic results output from the plurality of arithmetic and logic units.

2. The processor according to claim 1, wherein the first reduction circuit further includes a first shifter configured to shift an arithmetic result yielded by the first adder.

3. The processor according to claim 2, wherein the first reduction circuit further includes:
a first rounder configured to perform a rounding process on the arithmetic result thus shifted and to transmit the arithmetic result subjected to the rounding process; and
a first saturator configured to perform a saturation process on the arithmetic result subjected to the rounding process.

4. The processor according to claim 1, wherein the first reduction circuit transmits, to at least one of the plurality of arithmetic and logic units, an arithmetic result obtained in the first reduction circuit.

5. The processor according to claim 1, wherein the plurality of arithmetic and logic units simultaneously output their own arithmetic results.

6. An arithmetic processing device comprising a plurality of processors, each of the plurality of processors including:
a plurality of arithmetic and logic units configured to operate in parallel with one another; and
a first reduction circuit including a first adder configured to simultaneously add together a plurality of arithmetic results output from the plurality of arithmetic and logic units.

7. The arithmetic processing device according to claim 6, wherein in a case where the number of the plurality of arithmetic and logic units is 2ⁿ, (where n is an integer of 2 or greater), the first adder is configured to calculate 2ⁿ⁻¹ addition results by adding together 2ⁿ arithmetic results output from the plurality of arithmetic and logic units.

8. The arithmetic processing device according to claim 7, wherein the first adder is configured to repeat addition until n−1 becomes 0.

9. The arithmetic processing device according to claim 6, wherein the first reduction circuit further includes a first shifter configured to shift an arithmetic result yielded by the first adder.

10. The arithmetic processing device according to claim 9, wherein the first reduction circuit further includes:
a first rounder configured to perform a rounding process on the arithmetic result shifted by the first shifter and to transmit the arithmetic result subjected to the rounding process, and
a first saturator configured to perform a saturation process on the arithmetic result subjected to the rounding process.

11. The arithmetic processing device according to claim 6, wherein the first reduction circuit transmits, to at least one of the plurality of arithmetic and logic units, an arithmetic result obtained in the first reduction circuit.

12. The arithmetic processing device according to claim 6, further comprising an arbitration circuit configured to receive a plurality of arithmetic results respectively output from the plurality of processors and to transmit the plurality of arithmetic results thus received to a memory in sequence.

13. The arithmetic processing device according to claim 12, wherein the arbitration circuit acquires arithmetic results retained in the memory and transmits the arithmetic results thus acquired to the plurality of processors in sequence.

14. The arithmetic processing device according to claim 6, further comprising a second reduction circuit including a second adder configured to receive a plurality of arithmetic results respectively output from the plurality of processors and to simultaneously add together the plurality of arithmetic results, the second reduction circuit configured to transmit an arithmetic result to a memory.

15. The arithmetic processing device according to claim 9, further comprising a second reduction circuit including a second adder configured to receive a plurality of arithmetic results respectively output from the plurality of processors and to simultaneously add together the plurality of arithmetic results, the second reduction circuit configured to transmit an arithmetic result to a memory,
wherein each of the plurality of processors transmits, to the second adder, an arithmetic result shifted by the first shifter.

16. The arithmetic processing device according to claim 14, wherein the second reduction circuit further includes:
a second shifter configured to shift an arithmetic result yielded by the second adder;
a second rounder configured to perform a rounding process on the arithmetic result thus shifted; and
a second saturator configured to perform a saturation process on the arithmetic result subjected to the rounding process.

17. The arithmetic processing device according to claim 14, further comprising an arbitration circuit configured to receive arithmetic results from the second reduction circuit and to transmit the arithmetic results thus received to the memory in sequence,
wherein the arbitration circuit acquires arithmetic results retained in the memory and transmits the arithmetic results thus acquired to the plurality of processors in sequence.

18. The arithmetic processing device according to claim 6, wherein the plurality of arithmetic and logic units simultaneously output their own arithmetic results.

19. The arithmetic processing device according to claim 15, wherein the second reduction circuit further includes:
a second shifter configured to shift an arithmetic result yielded by the second adder,
a second rounder configured to perform a rounding process on the arithmetic result thus shifted, and
a second saturator configured to perform a saturation process on the arithmetic result subjected to the rounding process.

20. The arithmetic processing device according to claim 15, further comprising an arbitration circuit configured to receive arithmetic results from the second reduction circuit and to transmit the arithmetic results thus received to the memory in sequence,
wherein the arbitration circuit acquires arithmetic results retained in the memory and transmits the arithmetic results thus acquired to the plurality of processors in sequence.

21. An arithmetic processing method comprising:
performing a plurality of arithmetic operations and/or logic operations in parallel; and
simultaneously adding together arithmetic results of the plurality of arithmetic operations and/or logic operations,
wherein when the number of the arithmetic results is 2ⁿ, (where n is an integer of 2 or greater), simultaneously adding together the arithmetic results is calculating 2ⁿ⁻¹ addition results by adding together the 2ⁿ arithmetic results and repeating addition until n−1 becomes 0.
